(19) United States
(12) Patent Application Publication
(10) Pub. No.: US 2010/0245936 A1
(43) Pub. Date: Sep. 30, 2010

(54) IMAGE PROCESSING APPARATUS, IMAGE PROCESSING METHOD, AND PROGRAM

(75) Inventor: Motoki Yoshizawa, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/731,113

(22) Filed: Mar. 24, 2010

(30) Foreign Application Priority Data
Mar. 25, 2009 (JP) 2009-073820

(51) Int. Cl. H04N 1/40

(52) U.S. Cl. 358/461

(57) ABSTRACT

An image processing apparatus that performs shading correction processing with the use of white reference data is provided. The image processing apparatus includes a source data acquisition unit and a white reference data generation unit. The source data acquisition unit acquires source data for the white reference data. The white reference data generation unit generates the white reference data expressed with a predetermined number of bits from the source data acquired by the source data acquisition unit. The white reference data generation unit determines bit precision depending on the minimum value of the source data and generates the white reference data having the determined bit precision.

### BACKGROUND

1. Technical Field

The present invention relates to an image processing apparatus, an image processing method, and a program.

2. Related Art

Some image processing apparatuses such as scanners perform shading correction before the actual reading of an original document. The shading correction is performed in order to avoid unevenness in a read image that might otherwise occur due to, for example, uneven amount of light irradiated by a light source lamp, variation in the sensitivity of an image-reading element, or due to other reasons. An example of such an image processing apparatus is disclosed in JP-A-2002-262085. Quantized white reference data, quantized black reference data, and the like are used in shading correction.

Quantized data produces finer expression as the number of bits increases, which results in greater precision. Accordingly, if white reference data and black reference data that contain a large number of bits (i.e., data that have high bit precision) are used, it is possible to perform shading correction precisely.

However, an image processing apparatus that has a low memory bandwidth cannot process data that contains a large number of bits at a high speed. For this reason, such an image processing apparatus sometimes reduces the bit precision of white reference data, black reference data, and the like when performing shading correction. There is a demand for a technique that makes it possible to perform shading correction with as high precision as possible even in such a case.

### SUMMARY

An advantage of some aspects of the invention is to provide an image processing apparatus, an image processing method, and a program that make it possible to perform shading correction with as high precision as possible.

In order to address the above-identified problem without any limitation thereto, an image processing apparatus that performs shading correction processing with the use of white reference data is provided. An image processing apparatus according to a first aspect of the invention includes: a source data acquiring section that acquires source data for the white reference data; and a white reference data generating section that generates the white reference data expressed with a predetermined number of bits from the source data acquired by the source data acquiring section, wherein the white reference data generating section determines bit precision depending on the minimum value of the source data and generates the white reference data having the determined bit precision.

An image processing apparatus according to a second aspect of the invention, which performs shading correction processing with the use of white reference data, includes: a source data acquiring section that acquires source data for the white reference data; and a white reference data generating section that generates the white reference data expressed with a predetermined number of bits from the source data acquired by the source data acquiring section, wherein the white reference data generating section determines bit precision depending on a difference between the minimum value of the source data and the maximum value of the source data and generates the white reference data having the determined bit precision.

An image processing apparatus according to a third aspect of the invention, which performs shading correction processing with the use of white reference data, includes: a source data acquiring section that acquires source data for the white reference data; and a white reference data generating section that generates the white reference data expressed with a predetermined number of bits from the source data acquired by the source data acquiring section, wherein, in a case where the source data is data for a defective pixel, the white reference data generating section generates, from the source data, the white reference data that is expressed with the predetermined number of bits and has a value indicating that the source data is the defective pixel data (i.e., the data for the defective pixel).

### BRIEF DESCRIPTION OF THE DRAWINGS

The invention will be described with reference to the accompanying drawings, wherein like numbers reference like elements.

FIG. 1 is a block diagram that schematically illustrates an example of the configuration of an image processing apparatus according to an exemplary embodiment of the invention.

FIG. 2 is a graph that shows, for every pixel, an example of a brightness value indicated by scanned data for one line according to an exemplary embodiment of the invention.

FIG. 3A is a diagram that schematically illustrates an example of the data structure of scanned data according to an exemplary embodiment of the invention.

FIG. 3B is a diagram that schematically illustrates an example of the data structure of correction data according to an exemplary embodiment of the invention.

FIG. 4 is a diagram that schematically illustrates an example of the data structure of scanned data and correction data generated by an image processing apparatus according to related art.

FIG. 5A is a diagram that schematically illustrates an example of a method for generating white reference data when a first condition (Condition 1) according to an exemplary embodiment of the invention is met.

FIG. 5B is a diagram that schematically illustrates an example of offset conversion performed when the first condition according to an exemplary embodiment of the invention is met.

FIG. 6A is a diagram that schematically illustrates an example of a method for generating white reference data when a second condition (Condition 2) according to an exemplary embodiment of the invention is met.

FIG. 6B is a diagram that schematically illustrates an example of offset conversion performed when the second condition according to an exemplary embodiment of the invention is met.

FIG. 7 is a flowchart that schematically illustrates an example of correction data generation processing according to an exemplary embodiment of the invention.

FIG. 8 is a flowchart that schematically illustrates an example of shading correction processing according to an exemplary embodiment of the invention.

FIG. 9 is a diagram that schematically illustrates an example of a method for generating white reference data when Condition 2′ according to another embodiment of the invention is met.

### DESCRIPTION OF EXEMPLARY EMBODIMENTS

With reference to the accompanying drawings, an exemplary embodiment of the present invention will now be explained in detail.

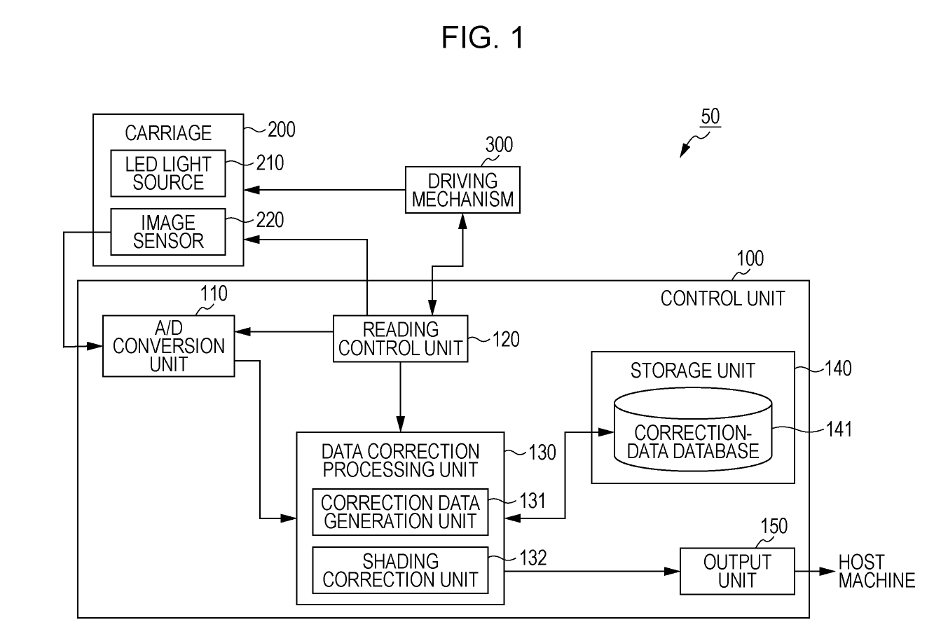

FIG. 1 is a block diagram that schematically illustrates an example of the configuration of an image processing apparatus 50 according to an exemplary embodiment of the invention.

The image processing apparatus 50 is, for example, a so-called flatbed scanning apparatus that is provided with an original document table. The original document table, which is not illustrated in the drawing, is provided at the upper surface of the body of the apparatus 50. Through the scanning movement of an image sensor 220, the image processing apparatus 50 reads an image of an original document that is placed on the original document table, which is a transparent plate.

As illustrated in FIG. 1, the image processing apparatus 50 is provided with a control unit 100, a carriage 200, and a driving mechanism 300. A light-emitting-diode (LED) light source 210 and the image sensor 220 are mounted on the carriage 200. The driving mechanism 300 supplies a driving force for, and controls, the movement of the carriage 200. The control unit 100 controls the entire operation of the image processing apparatus 50. The control unit 100 performs various control operations for image scanning.

The image processing apparatus 50 includes a mechanism for generating white reference data that is used for popular shading correction (i.e., shading compensation). For example, as the mechanism for generating white reference data or as a component of such a mechanism, the image processing apparatus 50 is provided with a white reference plate that has an even reflection surface with high reflectivity. The white reference plate is not illustrated in the drawing. Black reference data is also used in popular shading correction. However, it is not necessary to provide any special mechanism for generating black reference data in the image processing apparatus 50. To generate black reference data, for example, the image processing apparatus 50 performs reading operation with the LED light source 210 being turned OFF. As a result, black reference data is generated.

The carriage 200 carries the image sensor 220 together with the LED light source 210 in the sub-scan direction. The carriage 200 is movably supported on a guiding shaft or the like. The guiding shaft is provided parallel to the table plane of the original document table. A belt that turns when driven by a motor of the driving mechanism 300 is fixed to the carriage 200. Accordingly, the carriage 200 can slide on and travel along the guiding shaft as the belt turns under the power of the motor.

The LED light source 210 includes red, green, and blue LEDs. The LED light source 210 produces light of the three primary colors, that is, R, G, and B, in a predetermined sequential order. For example, the LED light source 210 produces light in the order of the red LED, the green LED, and the blue LED so as to read a white reference plate for one line. Then, the same light-emitting operation as above is repeated in order to read all lines of the white reference plate (i.e., the width of the white reference plate).

The image sensor 220 outputs a signal obtained by reading an original document or a white reference plate to the control unit 100. The signal is in the form of analog data that indicates brightness values of each of R, G, and B. Specifically, the image sensor 220 receives light reflected by an original document, a white reference plate, or the like, reads out electric charge that has accumulated in accordance with the amount of the received light as a voltage, and then outputs the readout voltage to the control unit 100.

The control unit 100 includes an analog-to-digital (A/D) conversion unit 110, a reading control unit 120, a data correction processing unit 130, a storage unit 140, and an output unit 150. The A/D conversion unit 110 converts analog data outputted from the image sensor 220, that is, a signal obtained as a result of reading operation (hereinafter referred to as “scanned signal”), into digital data (hereinafter referred to as “scanned data”). The data correction processing unit 130 performs shading correction processing on the scanned data taken from an original document, which has been outputted from the A/D conversion unit 110 (hereinafter referred to as “image data”). Data that is to be used by the data correction processing unit 130 for shading correction (white reference data and black reference data) is stored in the storage unit 140. The output unit 150 sends out the corrected image data, which has been subjected to shading correction, to a host machine such as a personal computer or the like. The reading control unit 120 controls the functional blocks of the control unit 100. In addition to the internal control, the reading control unit 120 controls the carriage 200 and the driving mechanism 300.

The reading control unit 120 controls the rotation of the motor of the driving mechanism 300, thereby controlling the movement of the carriage 200. In addition, the reading control unit 120 controls the reading operation of the image sensor 220, which includes image reading operation, reading operation for generating white reference data, and reading operation for generating black reference data. Moreover, the reading control unit 120 controls the ON/OFF state of the LED light source 210 in synchronization with the reading operation of the image sensor 220.

As described above, the A/D conversion unit 110 converts analog data outputted from the image sensor 220 (scanned signal) into digital data (scanned data). The digital data has a predetermined number of bits L (e.g., 16 bits). The A/D conversion unit 110 outputs the converted data to the data correction processing unit 130.

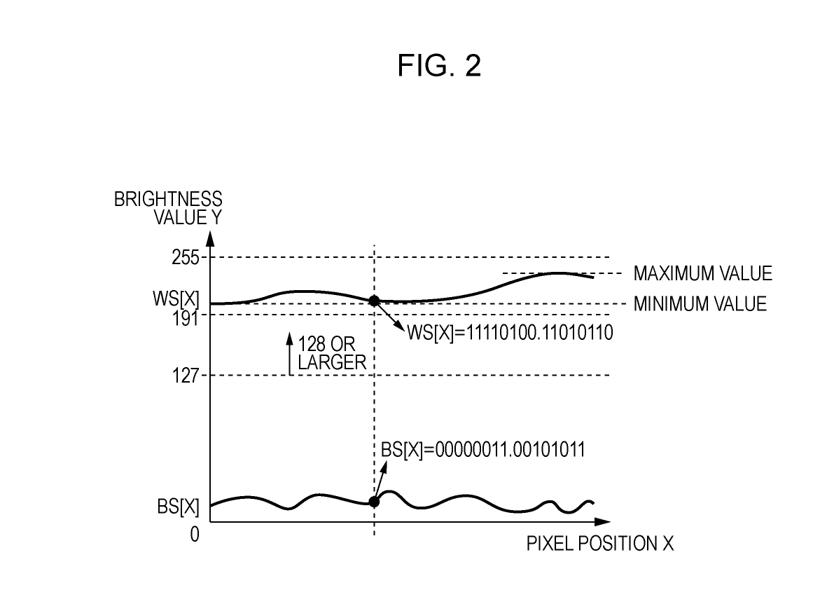

FIG. 2 is a graph that shows, for every pixel position, a brightness value indicated by each scanned data for one line. The horizontal axis of the graph represents pixel positions X. The vertical axis of the graph represents brightness values Y. In the graph, the brightness values Y of the vertical axis are shown as numeric values in the decimal numeral system for simplicity. However, actual brightness values outputted from the A/D conversion unit 110 to the data correction processing unit 130 are binary digital data with the predetermined number of bits L assigned to each color.

In the following description of this specification, scanned data that is outputted from the A/D conversion unit 110 in reading operation for generating white reference data is referred to as “white reference scan data” WS. The white reference scan data WS is source data for white reference data. Scanned data that is outputted from the A/D conversion unit 110 in reading operation for generating black reference data is referred to as “black reference scan data” BS. The black reference scan data BS is source data for black reference data.

FIG. 2 shows an example of the white reference scan data WS (i.e., brightness values for R, G, or B) and the black reference scan data BS (i.e., brightness values for R, G, or B). As illustrated in FIG. 2, the white reference scan data WS for one line and the black reference scan data BS for one line vary slightly, that is, are uneven, depending on pixels (pixel positions X).

Next, with reference to FIG. 2, the conversion of a scanned signal (analog data) for each color into scanned data (digital data), which is performed by the A/D conversion unit 110, is explained below. For example, when a scanned signal outputted from the image sensor 220 indicates a brightness value of “220.836” (which is represented in the decimal numeral system (base ten)), the A/D conversion unit 110 converts the scanned signal into 16-bit white reference scan data WS “11011100.11010110” and then outputs the converted data. In the illustrated example, eight bits are assigned to each of the integer portion of a value before the decimal point and the fractional portion of the value after the decimal point. In like manner, when a scanned signal outputted from the image sensor 220 indicates a brightness value of “3.168” (which is represented in the decimal numeral system), the A/D conversion unit 110 converts the scanned signal into 16-bit black reference scan data BS “00000011.00101011” and then outputs the converted data.

As illustrated in FIG. 1, the data correction processing unit 130 includes a correction data generation unit 131 and a shading correction unit 132.

The correction data generation unit 131 generates data that is to be used for shading correction (which includes white reference data and black reference data) on the basis of scanned data (i.e., the white reference scan data WS and the black reference scan data BS) outputted from the A/D conversion unit 110. The generated data may be hereinafter referred to as “correction data”.

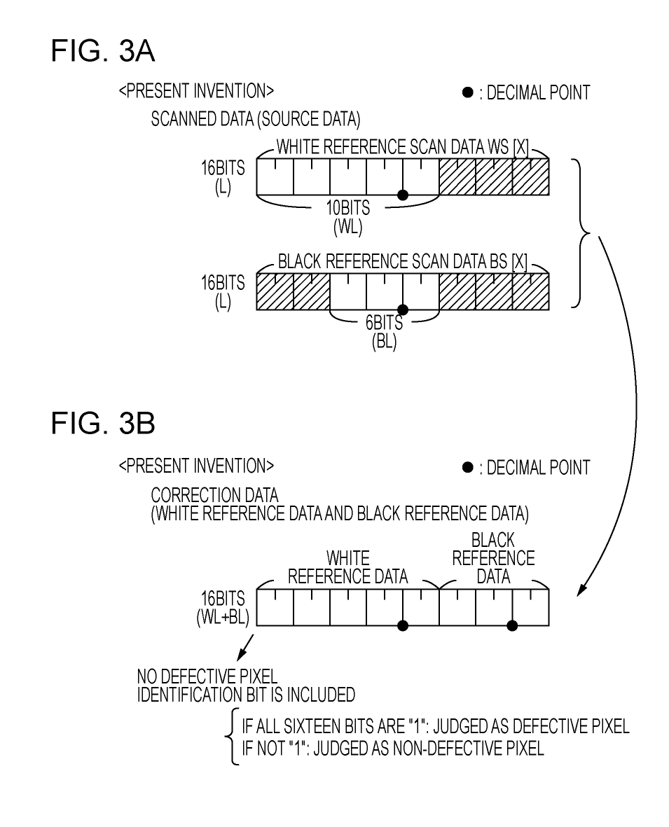

FIG. 3A is a diagram that schematically illustrates an example of the data structure of scanned data (i.e., the white reference scan data WS and the black reference scan data BS) outputted from the A/D conversion unit 110. Sixteen bits are assigned to the scanned data (i.e., each of the white reference scan data WS and the black reference scan data BS) for one color illustrated in FIG. 3A. The black point shown in the drawing indicates the position of the decimal point.

FIG. 3B is a diagram that schematically illustrates an example of the data structure of correction data that is generated by the correction data generation unit 131.

With reference to FIG. 3B, the generation of correction data by the correction data generation unit 131 is explained below. This processing is hereinafter referred to as “correction data generation processing”.

The correction data generation unit 131 receives the white reference scan data WS that contains the predetermined number of bits L (16 bits in the illustrated example) from the A/D conversion unit 110. The correction data generation unit 131 reduces the bit precision of the white reference scan data WS by decreasing the number of bits in order to reduce the amount of information. Specifically, the correction data generation unit 131 takes a partial bit string that contains a predetermined number of white bits WL out of the white reference scan data WS. The bit string that is extracted from the white reference scan data WS occupies predetermined bit positions in the entire bit string of the white reference scan data WS. In the illustrated example, six lower-order bits shown as shaded bits are truncated. Accordingly, ten higher-order bits remain after the truncation of the six lower-order bits. The bit string that contains the predetermined number of white bits WL (i.e., the ten higher-order bits in the illustrated example) after the reduction of bit precision is referred to as “white reference data”.

The correction data generation unit 131 receives the black reference scan data BS that contains the predetermined number of bits L (16 bits in the illustrated example) from the A/D conversion unit 110. The correction data generation unit 131 reduces the bit precision of the black reference scan data BS by decreasing the number of bits in order to reduce the amount of information. Specifically, the correction data generation unit 131 takes a partial bit string that contains a predetermined number of black bits BL out of the black reference scan data BS. The bit string that is extracted from the black reference scan data BS occupies predetermined bit positions in the entire bit string of the black reference scan data BS. In the illustrated example, four higher-order bits and six lower-order bits shown as shaded bits are truncated. Accordingly, six bits remain after the truncation of the four higher-order bits and the six lower-order bits. The bit string that contains the predetermined number of black bits BL (i.e., the six remaining bits in the illustrated example) after the reduction of bit precision is referred to as “black reference data”.

White reference data and black reference data are generated for each detection color (e.g., R, G, and B).

In the illustrated example, the number of bits assigned to black reference data (which is six) is smaller than the number of bits assigned to white reference data (which is ten). This is because the excessive part of bits assigned to the integer portion of a value before the decimal point would not be used effectively if too many bits were assigned to black reference data due to the smallness of the brightness values of the black reference data for each of R, G, and B (which are close to the value representing black, that is, “R=0”, “G=0”, and “B=0”.

The correction data generation unit 131 combines the white reference data taken out of the white reference scan data WS with the black reference data taken out of the black reference scan data BS to generate correction data. Accordingly, when the predetermined number of white bits WL and the predetermined number of black bits BL are assigned to the white reference data and the black reference data, respectively, the aggregate number of bits of the correction data can be denoted as WL+BL. In the illustrated example, the number of white bits WL that are assigned to the white reference data is ten. The number of black bits BL that are assigned to the black reference data is six. Therefore, the aggregate number of bits of the correction data is sixteen. It is assumed that white reference data is combined with black reference data for the same pixel and the same color each to generate correction data.

The correction data generation unit 131 can judge whether scanned data (i.e., the white reference scan data WS and the black reference scan data BS) is data for a defective pixel (i.e., data of a defective pixel) or not. If it is judged that the scanned data is data for a defective pixel, the correction data generation unit 131 generates correction data that has a predetermined value indicating that the data is defective-pixel data. For example, if it is judged that the scanned data is data for a defective pixel, the correction data generation unit 131 changes each of all bits of the white reference data and each of all bits of the black reference data into “0” (or “1”) when generating correction data.

That is, the correction data generation unit 131 generates correction data that has a predetermined value when it is judged that scanned data is data for a defective pixel; if the scanned data is data for a non-defective pixel, the correction data generation unit 131 combines white reference data with black reference data to generate correction data.

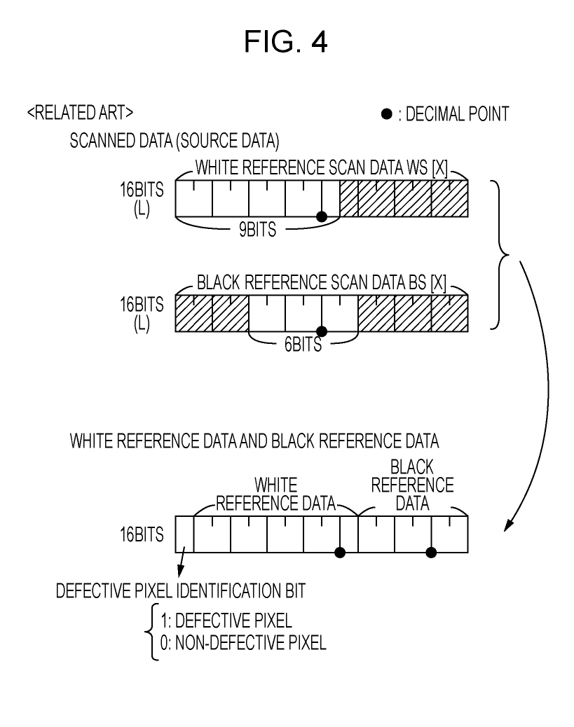

FIG. 4 is a diagram that schematically illustrates an example of the data structure of scanned data and correction data generated by an image processing apparatus according to related art.

As illustrated in FIG. 4, according to the data structure of related art, correction data includes one bit that is used for identifying whether scanned data is data for a defective pixel or not. This bit is hereinafter referred to as “defective pixel identification bit”. For example, if it is judged that scanned data is data for a defective pixel, correction data whose defective pixel identification bit is set as “1” is generated. If it is judged that the scanned data is data for a non-defective pixel, correction data whose defective pixel identification bit is set as “0” is generated. For this reason, if it is assumed that correction data having the related-art data structure contains the same number of bits L as that of the present embodiment of the invention (which is sixteen as illustrated in the drawing), it is inevitably necessary that the bit precision of either the white reference scan data WS or the black reference scan data BS should be decreased by one bit, that is, the number of the bit assigned to the defective pixel identification bit. In the illustrated example, the white reference data according to the present embodiment of the invention has 10-bit precision whereas the white reference data according to the related art has 9-bit precision.

Correction data having the data structure according to the present embodiment of the invention does not include any defective pixel identification bit. The image processing apparatus 50 generates correction data that has a predetermined value only in a case where scanned data is judged to be data for a defective pixel. For this reason, when the correction data according to the present embodiment of the invention contains the same number of bits L as that of the related art, it is possible to generate white reference data whose bit precision is higher than that of the related art or black reference data having higher bit precision.

The correction data generation unit 131 generates white reference data whose bit precision differs depending on whether predetermined conditions are satisfied or not.

### First Condition

For example, the correction data generation unit 131 generates white reference data whose bit precision is higher by one bit in a case where a first condition is met. The first condition is as follows; the minimum value of white reference scan data WS [X] for pixels X of one line (or a plurality of lines) is not smaller than the mean value in a given tonal range, which is 128 in the example illustrated in FIG. 2.

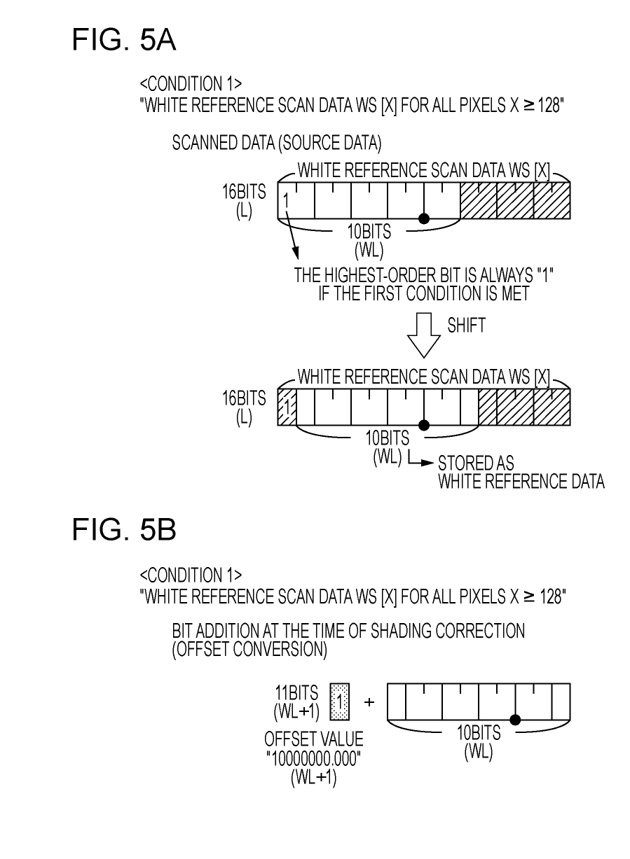

FIG. 5A is a diagram that schematically illustrates an example of a method for generating white reference data when the first condition according to an exemplary embodiment of the invention is met. Sixteen bits are assigned to the white reference scan data WS for one color illustrated in FIG. 5A. The black point shown in the drawing indicates the position of the decimal point.

As illustrated in FIG. 5A, the highest-order bit of the white reference scan data WS is always “1” when the first condition is met. Therefore, when the first condition is met, the bit precision of white reference data that is to be generated is set higher by one bit than otherwise. Specifically, the correction data generation unit 131 shifts the target bit positions of a bit string that contains the predetermined number of white bits WL and that will be extracted as white reference data by one bit to the right, that is, by one bit toward the lowest-order bit. Then, the correction data generation unit 131 informs the shading correction unit 132 of the mean value in the tonal range as an offset value (i.e., reference value). Or, the value of the highest-order bit only may be notified. A value “10000000.000”, which indicates the addition of one bit to the predetermined number of white bits WL of the white reference data and thus can be denoted as (WL+1) bits (e.g., eleven bits), is used as the offset value. Then, the correction data generation unit 131 combines the white reference data taken out of the white reference scan data WS with the black reference data taken out of the black reference scan data BS to generate correction data.

Since correction data has been generated in advance as explained above, it is possible to use white reference data whose bit precision is higher by one bit with aggregate bits of WL+1 in subsequent shading correction.

### Second Condition

For example, the correction data generation unit 131 generates white reference data whose bit precision is higher by one bit in a case where a second condition is met. The second condition is as follows; a value obtained as a result of subtraction of the minimum value of white reference scan data WS [X] for pixels X of one line (or a plurality of lines) from the maximum value thereof is not larger than a value corresponding to one half of a given tonal width, which is 128 in the example illustrated in FIG. 2.

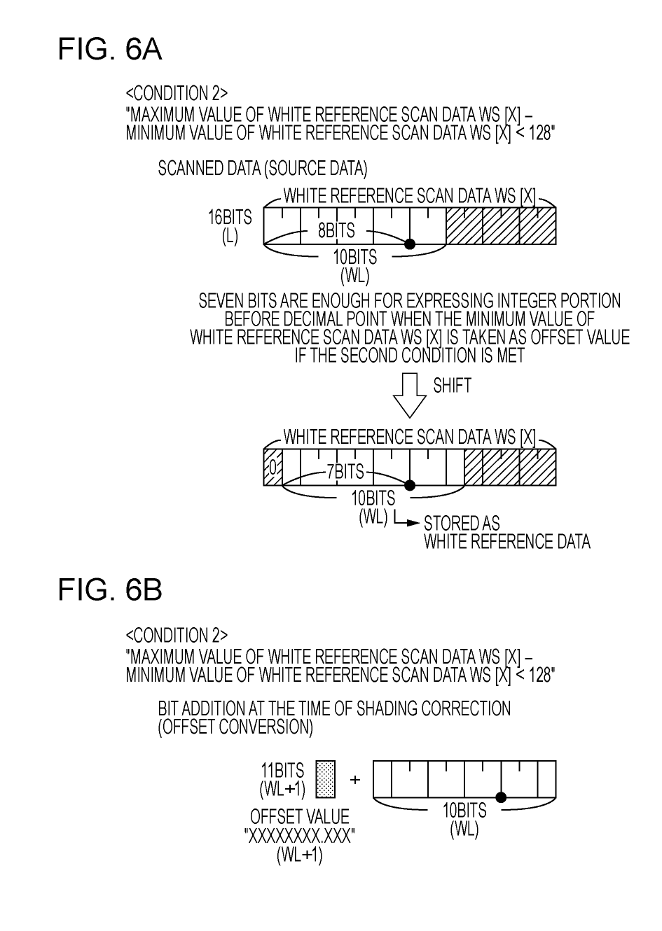

FIG. 6A is a diagram that schematically illustrates an example of a method for generating white reference data when the second condition according to an exemplary embodiment of the invention is met. Sixteen bits are assigned to the white reference scan data WS for one color illustrated in FIG. 6A. The black point shown in the drawing indicates the position of the decimal point.

As illustrated in FIG. 6A, in a case where the second condition is met, the number of bits assigned to the integer portion of a value before the decimal point can be decreased by one bit when the minimum value of white reference scan data WS [X] is taken as an offset value. In the illustrated example, seven bits are enough for bit expression. Therefore, when the second condition is met, the bit precision of white reference data that is to be generated is set higher by one bit than otherwise. Specifically, the correction data generation unit 131 subtracts the minimum value of the white reference scan data WS from the white reference scan data WS. As a result, the highest-order bit of the white reference scan data WS is always “0”. Accordingly, the correction data generation unit 131 shifts the target bit positions of a bit string that contains the predetermined number of white bits WL and that will be extracted as white reference data by one bit to the right, that is, by one bit toward the lowest-order bit. Then, the correction data generation unit 131 informs the shading correction unit 132 of the minimum value of the white reference scan data WS [X] as the offset value. The minimum value “xxxxxxxx.xxx”, which indicates the addition of one bit to the predetermined number of white bits WL of the white reference data and thus can be denoted as (WL+1) bits (e.g., eleven bits with the truncation of five lower-order bits), is used as the offset value. Then, the correction data generation unit 131 combines the white reference data taken out of the white reference scan data WS with the black reference data taken out of the black reference scan data BS to generate correction data.

Since correction data has been generated in advance as explained above, it is possible to use white reference data whose bit precision is higher by one bit with aggregate bits of WL+1 in subsequent shading correction.

Referring back to FIG. 1, the operation of the shading correction unit 132 is explained below.

The shading correction unit 132 performs shading correction processing on image data with the use of correction data generated by the correction data generation unit 131. Thereafter, the shading correction unit 132 outputs the corrected image data, which has been subjected to shading correction, to the output unit 150. In the following description of this specification, the processing performed by the shading correction unit 132 is referred to as “shading correction processing”.

In a case where the shading correction unit 132 received a notification of an offset value from the correction data generation unit 131, the shading correction unit 132 performs offset-conversion processing on white reference data included in correction data.

FIG. 5B is a diagram that schematically illustrates an example of offset conversion performed when the first condition according to an exemplary embodiment of the invention is met. FIG. 6B is a diagram that schematically illustrates an example of offset conversion performed when the second condition according to an exemplary embodiment of the invention is met.

As illustrated in each of FIGS. 5B and 6B, whenever either the first condition or the second condition is met, the shading correction unit 132 adds the offset value ((WL)+1 bit) notified from the correction data generation unit 131 to the white reference data (WL bits) taken out of the white reference scan data WS by the correction data generation unit 131 for offset conversion.

Then, the shading correction unit 132 carries out shading correction with the use of the white reference data that has been subjected to offset conversion and the black reference data included in the correction data.

As illustrated in FIG. 1, the storage unit 140 stores data that is to be used by the data correction processing unit 130 for shading correction. Specifically, the storage unit 140 includes a correction-data database (DB) 141 that is used for storing correction data (white reference data and black reference data) generated by the correction data generation unit 131. In addition, the storage unit 140 includes an image-data database, which is not illustrated in the drawing. Image data that has not been subjected to correction processing yet is stored in the image-data database.

The output unit 150 is provided with an interface for network connection or USB connection. The output unit 150 transmits the shading-corrected image data, which has been outputted from the data correction processing unit 130, to a host computer.

The image processing apparatus 50 according to the present embodiment of the invention has the configuration explained above. However, the configuration of the image processing apparatus 50 is not limited to the above example. For example, the image processing apparatus 50 may be provided with other additional unit(s) for functioning as a multifunction printer, a copier, or the like.

The main components of the control unit 100 can be embodied as components of a general purpose computer that includes a CPU functioning as a main controller, a ROM in which programs and the like are stored, a RAM that is used for the temporary storage of data and the like as a main memory device, an interface that controls the input of a signal from and the output of a signal to the host computer and the like, and a system bus functioning as an internal communication channel between the components. They may be embodied as an application specific integrated circuit (ASIC) that is customized to perform each processing. The A/D conversion unit 110 may be embodied as an analog-front-end (AFE) integrated circuit.

It should be noted that the above components show mere exemplary constituent elements that include functional blocks separated from one another on the basis of the basic and primary content of processing just for the purpose of facilitating the understanding of the configuration of the image processing apparatus 50. The specific manner of the separation of components and the names thereof used in this specification is not intended to restrict the scope of the invention. Any component of the image processing apparatus 50 may be further divided into sub-components in accordance with the content of processing. A single component may double as two or more functional blocks. Processing performed by each component may be implemented by one hardware device or a plurality of hardware devices.

### Correction Data Generation Processing

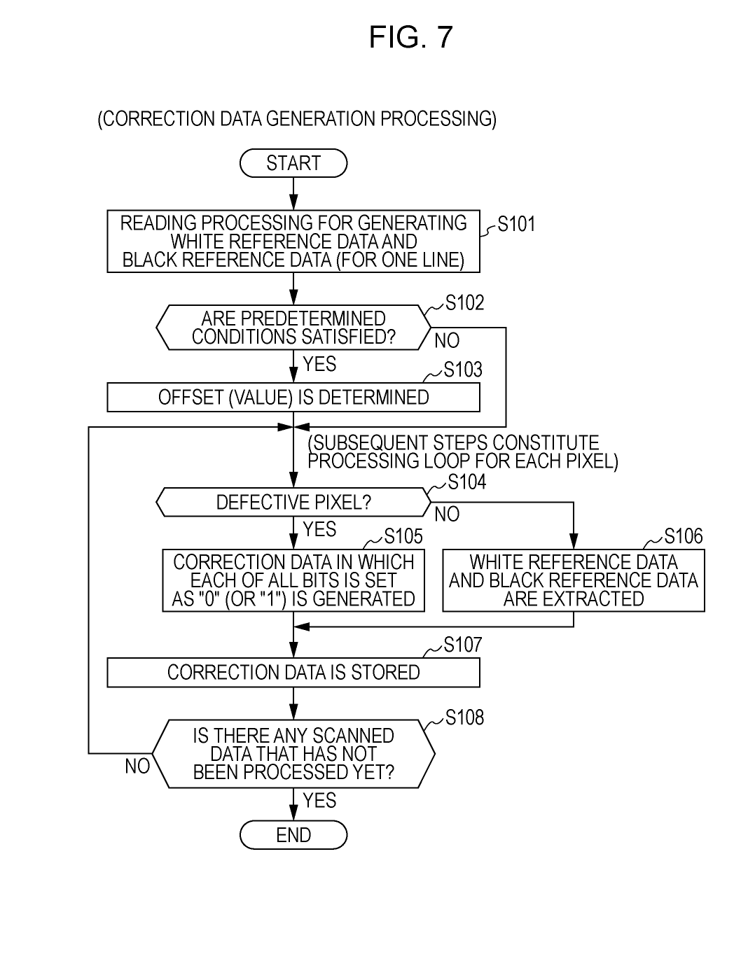

Next, the characteristic operation of the image processing apparatus 50 having the above configuration is explained below. FIG. 7 is a flowchart that schematically illustrates an example of correction data generation processing performed by the image processing apparatus 50 according to an exemplary embodiment of the invention.

As a first step, before the reading of an original document, the reading control unit 120 performs reading processing for generating white reference data and reading processing for generating black reference data (step S101).

In the reading processing for generating white reference data, for example, the reading control unit 120 controls the driving mechanism 300 to move the carriage 200 to a predetermined reading position. Then, the reading control unit 120 sets the LED light source 210 ON and causes the image sensor 220 to receive reflected light that comes from a white reference plate. Electric charge accumulates in the image sensor 220 on a pixel-by-pixel basis in accordance with the amount of the received light. The reading control unit 120 causes the image sensor 220 to transfer an electric signal (i.e., analog data) obtained through the accumulation of electric charge thereat to the A/D conversion unit 110 as a white reference scan signal, which has been obtained as a result of reading the white reference plate.

In the reading processing for generating black reference data, the reading control unit 120 causes the image sensor 220 to receive light for a predetermined time period while setting the LED light source 210 OFF. The reading control unit 120 causes the image sensor 220 to transfer an electric signal (i.e., analog data) obtained through the accumulation of electric charge thereat to the A/D conversion unit 110 as a black reference scan signal, which is used for generating black reference data.

Then, as explained earlier, the A/D conversion unit 110 converts the scanned signal outputted from the image sensor 220 into digital data (the white reference scan data WS and the black reference scan data BS) to which the predetermined number of bits L (e.g., 16 bits) are assigned for each color. The A/D conversion unit 110 outputs the digital data to the data correction processing unit 130.

When the data correction processing unit 130 receives the scanned data (the white reference scan data WS and the black reference scan data BS) outputted from the A/D conversion unit 110 for one line (or a plurality of lines), the process proceeds to a step S102.

For the scanned data for one line (or a plurality of lines) received in the step S101, the correction data generation unit 131 of the data correction processing unit 130 judges whether predetermined conditions (e.g., the first condition and the second condition explained above) are satisfied or not (step S102). For example, the correction data generation unit 131 finds the minimum value of white reference scan data WS [X] for pixels X of one line (or a plurality of lines) and the maximum value thereof. The correction data generation unit 131 judges that the first condition is met if the found minimum value is not smaller than the mean value in a given tonal range. The correction data generation unit 131 judges that the second condition is met if a value obtained as a result of subtraction of the found minimum value from the found maximum value is not larger than a value corresponding to one half of a given tonal width.

In a case where the correction data generation unit 131 judges that at least one of the conditions is met (step S102: YES), the process proceeds to a step S103. In a case where the correction data generation unit 131 judges that neither (or none) of the conditions is met (step S102: NO), the process proceeds to a step S104.

In the step S103, the correction data generation unit 131 determines an offset value for white reference data in order to generate the white reference data having higher bit precision. For example, the correction data generation unit 131 sets the mean value in a given tonal range as the offset value when it was judged in the step S102 that the first condition is met. The correction data generation unit 131 sets the minimum value of the white reference scan data WS as the offset value when it was judged in the step S102 that the second condition is met.

Thereafter, the correction data generation unit 131 notifies the determined offset value to the shading correction unit 132. Then, the process proceeds to a step S104.

In the step S104, the correction data generation unit 131 initiates the following loop processing (from the step S104 inclusive to a step S108 inclusive) on a color-by-color basis (RGB) for each pixel.

As a first step of the loop processing, the correction data generation unit 131 judges whether the scanned data received in the step S101 is data for a defective pixel or not (step S104). A well-known judgment method can be used for judging whether the scanned data is data for a defective pixel or not. For example, it is judged that the scanned data is data for a defective pixel when the scanned data indicates a value that cannot be used as a brightness value. Or, the scanned data is judged as data for a defective pixel when it indicates an inappropriate value when compared with the value of scanned data of other adjacent pixel.

When the correction data generation unit 131 judges that the scanned data is not data for a defective pixel (step S104: NO), the process proceeds to a step S106. When the correction data generation unit 131 judges that the scanned data is data for a defective pixel (step S104: YES), the process proceeds to a step S105.

In the step S105, the correction data generation unit 131 generates correction data that has a predetermined value indicating that the data is defective-pixel data. For example, as explained earlier, the correction data generation unit 131 generates correction data in which each of all bits is set as “0” (or “1”). That is, in a case where sixteen bits are assigned to the correction data, each of all sixteen bits is set as “0” (or “1”).

Next, the correction data generation unit 131 puts the correction data generated in the step S105 in the correction-data DB 141 of the storage unit 140 for data storage (step S107). After the storage of the correction data, the process proceeds to a step S108.

In a case where the process has proceeded to the step S106 from the step S104, the correction data generation unit 131 takes white reference data and black reference data out of the white reference scan data WS and the black reference scan data BS received in the step S101, respectively (step S106).

For example, as illustrated in FIG. 5A, the correction data generation unit 131 shifts the target bit positions of a bit string that occupies predetermined bit places in the entire bit string of the white reference scan data WS and that will be extracted as white reference data by one bit to the right when it was judged in the step S102 that the first condition is met. Specifically, the bit positions move from the ten higher-order bits by one bit toward the lowest-order bit. The correction data generation unit 131 extracts the shifted bit string from the white reference scan data WS as the white reference data. In other words, the correction data generation unit 131 takes the bit string that remains after the truncation of the highest-order bit and the five lower-order bits out of the white reference scan data WS as the white reference data. In addition, the correction data generation unit 131 extracts a bit string that occupies predetermined bit places in the entire bit string of the black reference scan data BS from the black reference scan data BS as black reference data. Specifically, as illustrated in FIG. 3A, the correction data generation unit 131 takes the bit string that remains after the truncation of the four higher-order bit and the six lower-order bits out of the black reference scan data BS as the black reference data.

As illustrated in FIG. 6A, the correction data generation unit 131 shifts the target bit positions of a bit string that occupies predetermined bit places in the entire bit string of the white reference scan data WS and that will be extracted as white reference data by one bit to the right when it was judged in the step S102 that the second condition is met. Specifically, the bit positions move from the ten higher-order bits by one bit toward the lowest-order bit. The correction data generation unit 131 extracts the shifted bit string from the white reference scan data WS as the white reference data. In other words, the correction data generation unit 131 takes the bit string that remains after the truncation of the highest-order bit and the five lower-order bits out of the white reference scan data WS as the white reference data. In addition, as done in the case of the satisfaction of the first condition, the correction data generation unit 131 extracts a bit string that occupies predetermined bit places in the entire bit string of the black reference scan data BS from the black reference scan data BS as black reference data. Specifically, the correction data generation unit 131 takes the bit string that remains after the truncation of the four higher-order bit and the six lower-order bits out of the black reference scan data BS as the black reference data.

When it was judged in the step S102 that neither the first condition or the second condition is met, which means that the processing of the step S103 was skipped, the correction data generation unit 131 extracts a bit string that occupies predetermined bit places in the entire bit string of the white reference scan data WS from the white reference scan data WS as white reference data. Specifically, as illustrated in FIG. 3A, the correction data generation unit 131 takes the bit string that remains after the truncation of the six lower-order bits out of the white reference scan data WS as the white reference data. In addition, the correction data generation unit 131 extracts a bit string that occupies predetermined bit places in the entire bit string of the black reference scan data BS from the black reference scan data BS as black reference data. Specifically, the correction data generation unit 131 takes the bit string that remains after the truncation of the four higher-order bit and the six lower-order bits out of the black reference scan data BS as the black reference data.

Next, the correction data generation unit 131 combines the white reference data extracted in the step S106 with the black reference data extracted in the step S106 to generate correction data, which is then stored in the correction-data DB 141 of the storage unit 140 (step S107). After the storage of the correction data, the process proceeds to the step S108.

In the step S108, the correction data generation unit 131 judges whether or not there is any scanned data that has not been processed yet among the scanned data (for one line) that was received in the step S101 (step S108).

If it is judged that there is some scanned data that has not been processed yet (step S108: YES), the process returns to the step S104. In this case, the correction data generation unit 131 performs the loop processing from the steps S104 to S107 for the scanned data that has not been processed yet.

If it is judged that there is not any scanned data that has not been processed yet (step S108: NO), the correction data generation unit 131 ends the correction data generation processing.

### Shading Correction Processing

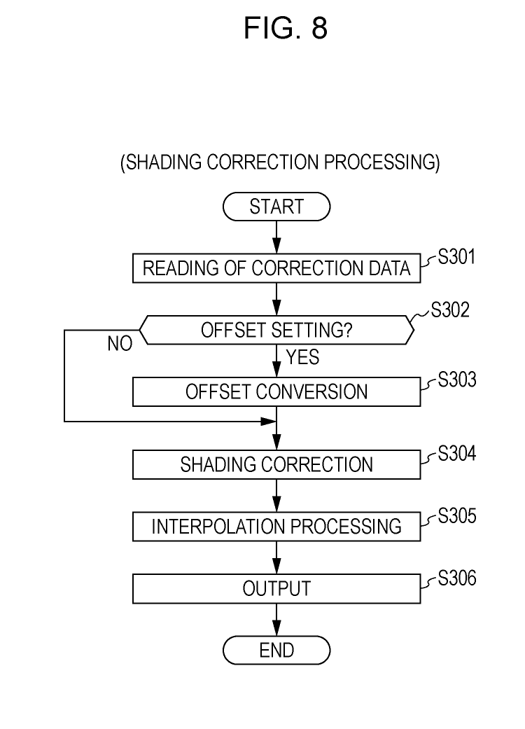

Next, shading correction processing is explained. FIG. 8 is a flowchart that schematically illustrates an example of shading correction processing performed by the image processing apparatus 50 according to an exemplary embodiment of the invention.

For example, the shading correction unit 132 starts shading correction processing at a point in time at which a request for shading correction is received from a user. Or, the shading correction unit 132 starts shading correction processing at a point in time at which image data (i.e., scanned data taken from an original document) is stored in the storage unit 140.

As a first step of the shading correction processing, the shading correction unit 132 reads out correction data stored in the correction-data DB 141 of the storage unit 140 (step S301). The shading correction unit 132 may read out correction data for one line. Or, the shading correction unit 132 may read out correction data for one pixel (or one color).

Next, the shading correction unit 132 judges whether offset setting is enabled or not for the correction data (on a color-by-color basis) that was read out in the step S301 (step S302). For example, the shading correction unit 132 judges whether an offset value was notified from the correction data generation unit 131 in the step S103 or not. If the shading correction unit 132 received a notification of an offset value, it judges that offset setting has been configured. If there was no notification of an offset value, the shading correction unit 132 judges that offset setting has not been configured.

The process proceeds to a step S303 for each correction data (for color) for which it is judged by the shading correction unit 132 that offset setting has been configured (step S302: YES). The shading correction unit 132 carries out offset conversion for the correction data (step S303). Offset conversion is skipped for correction data for which it is judged by the shading correction unit 132 that offset setting has not been configured (step S302: NO). For this data, the process proceeds to a step S304.

In the step S303, the shading correction unit 132 carries out offset conversion for the correction data for which it is judged that offset setting has been configured (step S302: YES). Specifically, the shading correction unit 132 adds the offset value ((WL)+1 bit) notified from the correction data generation unit 131 in the step S103 to the value of the white reference data (the predetermined number of white bits WL) included in the correction data. As a result, white reference data after offset conversion that has bit precision higher than that of white reference data before offset conversion, which contains the predetermined number of white bits WL, by one bit is generated.

In the step S304, the shading correction unit 132 carries out shading correction with the use of white reference data and black reference data. Specifically, the shading correction unit 132 reads image data out of the storage unit 140 and performs shading correction with the use of white reference data and black reference data that correspond to each of pixels that make up the read image data.

In a case where white reference data has been subjected to offset conversion in the step S303, the shading correction unit 132 uses the offset-converted white reference data and the black reference data included in the correction data for shading correction. In a case where white reference data has not been subjected to offset conversion, the shading correction unit 132 uses the white reference data included in the correction data and the black reference data included in the correction data for shading correction.

The shading correction unit 132 does not perform shading correction for correction data that indicates defective-pixel data. For example, in a case where each of the predetermined number of bits L, for example, 16 bits, of correction data is set as “0” (or “1”), the shading correction unit 132 recognizes that a pixel corresponding to the correction data is defective. In this case, the shading correction unit 132 does not perform shading correction for this pixel.

After the shading correction, the shading correction unit 132 performs interpolation processing on image data of the pixel recognized as defective (step S305). For example, the shading correction unit 132 uses image data (after shading correction) of a pixel that is next to the defective pixel for interpolation. In the step S305, the shading correction unit 132 does not perform interpolation processing on image data of any pixel that is not recognized as defective.

Then, the shading correction unit 132 outputs image data that has been subjected to shading correction or interpolation processing to a host machine via the output unit 150 (step S306).

Thereafter, the shading correction unit 132 ends the shading correction processing.

Since the image processing apparatus 50 performs the correction data generation processing (including the offset processing) and the shading correction processing explained above, it is possible to generate white reference data whose bit precision is higher in comparison with a case where a defective pixel identification bit is included in correction data.

In addition, it is possible to generate white reference data while making the bit precision thereof as high as possible depending on condition satisfied by the white reference scan data WS [X]. For example, it is possible to determine bit precision depending on the minimum value of white reference scan data WS [X] and generate white reference data having the determined bit precision (the first condition). It is possible to determine bit precision depending on a value obtained as a result of subtraction of the minimum value of white reference scan data WS [X] from the maximum value thereof, that is, a difference therebetween, and generate white reference data having the determined bit precision (the second condition).

Consequently, even when white reference data and black reference data are expressed as bit data containing a limited number of bits, that is, data having low bit precision, it is still possible to perform shading correction with improved precision.

The scope of the invention is not limited to an exemplary embodiment described above. The invention may be modified, adapted, changed, or improved in a variety of modes in its actual implementation.

### Modified Second Condition

As an application example of the foregoing second condition, the correction data generation unit 131 may generate white reference data whose bit precision is higher by two bits in a case where a modified second condition (hereinafter may be referred to as condition 2′) is met. The condition 2′ is as follows; a value obtained as a result of subtraction of the minimum value of white reference scan data WS [X] for pixels X of one line (or a plurality of lines) from the maximum value thereof is not larger than a value corresponding to a quarter of a given tonal width, which is 64 in the example illustrated in FIG. 2.

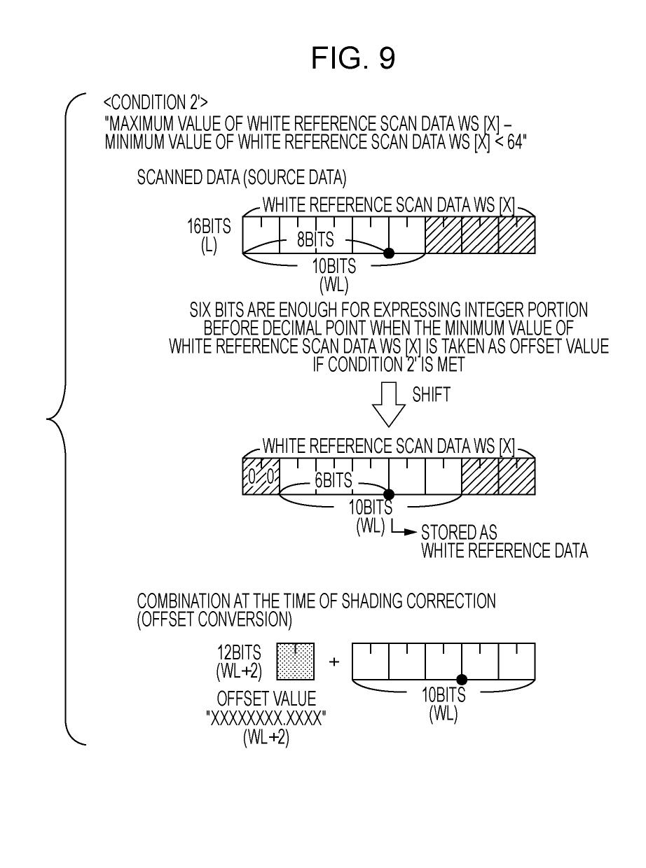

FIG. 9 is a diagram that schematically illustrates an example of a method for generating white reference data when the condition 2′ according to another embodiment of the invention is met. In FIG. 9, sixteen bits are assigned to the white reference scan data WS for one color for one pixel. The black point shown in the drawing indicates the position of the decimal point.

As illustrated in FIG. 9, in a case where the condition 2′ is met, the number of bits assigned to the integer portion of a value before the decimal point can be decreased by two bits when the minimum value of white reference scan data WS [X] is taken as an offset value. In the illustrated example, six bits are enough for bit expression. Therefore, when the condition 2′ is met, the bit precision of white reference data that is to be generated is set higher by two bits than otherwise. Specifically, the correction data generation unit 131 subtracts the minimum value of the white reference scan data WS from the white reference scan data WS. As a result, the highest-order bit of the white reference scan data WS and the second highest-order bit thereof are always “00”. Accordingly, the correction data generation unit 131 shifts the target bit positions of a bit string that contains the predetermined number of white bits WL and that will be extracted as white reference data by two bits to the right, that is, by two bits toward the lowest-order bit. Then, the correction data generation unit 131 informs the shading correction unit 132 of the minimum value of the white reference scan data WS [X] as the offset value. The minimum value “xxxxxxxx.xxxx”, which indicates the addition of two bits to the predetermined number of white bits WL of the white reference data and thus can be denoted as (WL+2) bits (e.g., twelve bits with the truncation of four lower-order bits), is used as the offset value. The correction data generation unit 131 combines the white reference data taken out of the white reference scan data WS with the black reference data taken out of the black reference scan data BS to generate correction data.

Since correction data has been generated in advance as explained above, it is possible to use white reference data whose bit precision is higher by two bits with aggregate bits of WL+2 in subsequent shading correction.

The condition is not limited to the second condition (Condition 2) and the modified second condition (Condition 2′) explained above. The correction data generation unit 131 may generate white reference data whose bit precision is higher by k bits in a case where a value obtained as a result of subtraction of the minimum value of white reference scan data WS [X] for pixels X of one line (or a plurality of lines) from the maximum value thereof is not larger than a value corresponding to ½ k of a given tonal width in the same manner as done in the exemplary embodiments.

In the foregoing embodiment of the invention, it is explained that the shading correction unit 132 performs interpolation processing on image data. However, the scope of the invention is not limited to such an example. For example, interpolation processing may be performed on correction data. Or, a method of interpolation processing may be changed depending on the value of correction data. For example, in a case where each of all bits of correction data is set as “0”, the shading correction unit 132 performs interpolation processing on black reference data included in the correction data before the execution of shading correction. Then, the shading correction unit 132 performs shading correction processing with the use of the interpolated black reference data. In a case where each of all bits of correction data is set as “1”, the shading correction unit 132 performs interpolation processing on image data that has been subjected to shading correction in the same manner as done in the exemplary embodiment.

What is claimed is:

1. An image processing apparatus that performs shading correction processing with the use of white reference data, comprising:
a source data acquiring section that acquires source data for the white reference data; and
a white reference data generating section that generates the white reference data expressed with a predetermined number of bits from the source data acquired by the source data acquiring section,
wherein the white reference data generating section determines bit precision depending on the minimum value of the source data and generates the white reference data having the determined bit precision.

2. An image processing apparatus that performs shading correction processing with the use of white reference data, comprising:
a source data acquiring section that acquires source data for the white reference data; and
a white reference data generating section that generates the white reference data expressed with a predetermined number of bits from the source data acquired by the source data acquiring section,
wherein the white reference data generating section determines bit precision depending on a difference between the minimum value of the source data and the maximum value of the source data and generates the white reference data having the determined bit precision.

3. An image processing apparatus that performs shading correction processing with the use of white reference data, comprising:
a source data acquiring section that acquires source data for the white reference data; and
a white reference data generating section that generates the white reference data expressed with a predetermined number of bits from the source data acquired by the source data acquiring section,
wherein, in a case where the source data is data for a defective pixel, the white reference data generating section generates, from the source data, the white reference data that is expressed with the predetermined number of bits and has a value indicating that the source data is the defective pixel data.
